(19) United States
(12) Patent Application Publication
(10) Pub. No.: US 2020/0084544 A1
(43) Pub. Date: Mar. 12, 2020

(54) A COMMUNICATIONS SYSTEM

(71) Applicant: Bluekey Ptd Ltd, Queensland (AU)

(72) Inventor: Jai Dylan BENTLEY, Queensland (AU)

(21) Appl. No.: 16/468,881

(22) PCT Filed: Dec. 12, 2017
(86) PCT No.: PCT/AU2017/051374

§ 371 Date: Jun. 12, 2019

Related U.S. Application Data
(60) Provisional application No. 62/433,220, filed on Dec. 12, 2016.

(51) Int. Cl. H04R 3/12; G10L 21/0232; H04R 1/02; H04R 1/40; G06F 3/16; H04R 27/00; H04R 29/00

(52) U.S. Cl. CPC H04R 3/12; G10L 21/0232; H04R 1/026; H04R 1/403; H04R 2227/003; H04R 27/00; H04R 1/025; H04R 29/004; G06F 3/162

(57) ABSTRACT

A communications system includes a local area network that is configured for streaming multiple channels of digital media and a plurality of communications units. A network interface is configured for connecting the communications unit to the network. Digital signal processors are connected to the network interface to process signals received from and sent to the network. Analogue inputs are connected to sound sources and to the digital signal processors so that analogue signals generated by the analogue inputs can be digitised and received by the network. Audio outputs are configured to generate sound output. The audio outputs are connected to the digital signal processors. Controllers control operation of the communications unit.

### FIELD OF THE INVENTION

Various embodiments of a communications system, a communications unit and a method of distributing media on a local area network are described herein.

### BACKGROUND OF THE INVENTION

Courtrooms and other venues that accommodate two-way communications between two or more parties, with each party having one or more members, often require a sound system that can facilitate such communications. Such sound systems often consist of an analogue-type microphone positioned near each of the relevant members, for example, judges, prosecutors, defendants and witnesses. Cables from these microphones are fed into a centralised hub, where they are transmitted onto a public-address system in the form of a set of speakers mounted to a ceiling of the courtroom.

However, such systems typically require large amounts of cabling, which can be complex and expensive to install. Further, poor clarity of the sound being produced can result in delays, re-questioning, and potentially incorrect decisions being made. Such poor clarity is also not conducive to use with transcription or speech to text software.

### SUMMARY OF THE INVENTION

According to one aspect, there is provided a communications system that includes:

a local area network that is configured for streaming multiple channels of digital media; and

a plurality of communications units, each communications unit including:
a network interface configured for connecting the communications unit to the network;
a digital signal processor connected to the network interface to process signals received from and sent to the network;
an analogue input for connection to a sound source, the analogue input being connected to the digital signal processor so that analogue signals generated by the analogue input can be digitised and received by the network, via the digital signal processor;
an audio output that is configured to generate sound output, the audio output being connected to the digital signal processor so that a digital input from the network can be processed into analogue signals for the audio output; and
a controller that is configured to control operation of the communications unit.

The network may include an ethernet cable.

Each analogue input may be a balanced analogue input.

Each communications unit may include an amplifier that is connected between the digital signal processor and the audio output to amplify the analogue signals for the audio output.

Each communications unit may include a reference microphone configured to detect ambient noise and to generate an audio signal representing the ambient noise such that the audio signal can be used to filter out the ambient noise.

Each communications unit may include a housing, the audio output being a speaker array that is mounted on the housing. The audio output may include a speaker array controller connected to the speaker array so that the speaker array can generate sound output in different dispersion patterns.

Each communication unit may include a presence detector that is connected to the controller, the controller being configured to adjust a dispersion pattern of the audio output, via the speaker array controller, based on a signal received from the presence detector.

The analogue input may include a microphone connection mechanism that is operatively connected to the digital signal processor and is configured to facilitate connection of the sound source in the form of a microphone to the communications unit in a detachable manner.

The microphone connection mechanism may include a socket mounted in the housing to permit a microphone plug to be plugged into and out of the housing.

The communications system may include at least one input/output (I/O) unit, the, or each, I/O unit including:

a network interface configured for connecting the I/O unit to the network;

a digital signal processor connected to the network interface;

an analogue input for connection to at least one analogue input device, the analogue input being connected to the digital signal processor so that digitised input signals from the at least one analogue input device can be received by the network, via the interface;

an analogue output for connection to at least one analogue output device, the analogue output being connected to the digital signal processor so that digitised output signals can be received by the analogue output and transmitted as analogue signals to the, or each, analogue output device; and a controller that is configured to control operation of the I/O unit.

The communications system may include at least one amplifier unit, the, or each, amplifier unit including:

a network interface for connecting the amplifier unit to the network;

a digital signal processor connected to the network interface;

an amplifier for connection to one or more speakers, the amplifier being connected to the digital signal processor so that digitised audio signals can be received by the amplifier from the network and converted into amplified analogue signals for the speakers; and

a controller that is configured to at least control operation of the amplifier unit.

According to another aspect, there is provided a communications unit that includes:

a network interface configured for connecting the communications unit to a local area network that is configured for streaming multiple channels of digital media;

a digital signal processor connected to the network interface to process signals received from and sent to the network;

an analogue input for connection to a sound source, the analogue input being connected to the digital signal processor so that analogue signals received by the analogue input can be digitised and received by the network, via the digital signal processor;

an audio output that is configured to generate sound output, the audio output being connected to the digital signal processor so that a digital input from the network can be processed into analogue signals for the audio output; and

a controller that is configured to at least control operation of the communications unit.

The communications unit can be one of the communications units of the communications system described above.

According to another aspect there is provided a method of distributing media on a local area network that is configured for streaming multiple channels of digital media, the method including the steps of:

receiving and transmitting digital signals between a communications unit and the network via a network interface that is configured for connecting the communications unit to the network;

processing the digital signals with a digital signal processor connected to the network interface;

receiving analogue signals with an analogue input for connection to a sound source, the analogue input being connected to the digital signal processor;

digitising and transmitting the signals received from the analogue input to the network via the digital signal processor and the network interface;

receiving digitised audio signals from the network, via the network interface and the digital signal processor with an audio output; and

generating sound output with the audio output,

The method may include the step of amplifying the audio signals with an amplifier connected between the digital signal processor and the audio output.

The method may include the step of generating the sound output with a speaker array in a dispersion pattern.

The method may include the step of detecting the presence of one or more participants with a presence detector and adjusting the dispersion pattern based on a signal received from the presence detector.

The method may include the step of detecting ambient noise with a reference microphone and generating an audio signal representing the ambient noise such that the audio signal can be used to filter out the ambient noise.

The claims as filed and attached with this specification are hereby incorporated by reference into the text of the present description.

The accompanying drawings, which are incorporated in and constitute a part of this specification, illustrate several embodiments of the invention and together with the description, explain the principles of the invention.

### DESCRIPTION OF THE DRAWINGS

FIG. 1 shows a schematic layout of a courtroom with an example of a communications system installed in the courtroom.

FIG. 2 shows a schematic layout of a courtroom with the communications system installed, showing hearing zones generated by communications units of the communications system.

FIG. 3 shows a schematic diagram of the communications system having a local area network that is configured for streaming multiple channels of digital media.

FIG. 4 shows a schematic diagram of one example of a communications unit.

FIG. 5 shows a schematic diagram of an input/output (I/O) unit.

FIG. 6 shows a schematic diagram of an amplifier unit.

FIG. 7 shows a top rear perspective view of the communications unit.

FIG. 8 shows a top front perspective view of the communications unit.

FIG. 9 shows a bottom front perspective view of the communications unit.

FIG. 10 shows a top front perspective view of the communications unit without a speaker cover.

FIG. 11 shows a top rear assembly view of the communications unit with a connected ethernet cable of the network.

FIG. 12 shows a top front perspective view of the communications unit with a microphone connected to the communications unit.

FIG. 13 shows a top front perspective view of the I/O unit.

FIG. 14 shows a bottom front perspective view of the I/O unit.

FIG. 15 shows a front view of the I/O unit.

FIG. 16 shows a top front perspective view of the amplifier unit.

FIG. 17 shows a top rear perspective view of the amplifier unit.

FIG. 18 shows a bottom front perspective view of the amplifier unit.

FIG. 19 shows a bottom front perspective assembly view of the communications unit showing a mounting bracket.

FIG. 20 shows a bottom view of the communications unit.

FIG. 21 shows a cutaway side view of the communications unit, showing the mounting of the mounting bracket.

### DESCRIPTION OF EMBODIMENTS

In the drawings, a communications module or unit is generally indicated by reference numeral 100. An input/output (I/O) module or unit is generally indicated by reference numeral 200. A controller is generally indicated by reference numeral 300. An amplifier module unit is generally indicated by reference numeral 400. A communications system for use in a method of distributing media on a local area network is generally indicated by reference numeral 1000. The local area network is generally indicated by reference numeral 2000 and is configured for streaming multiple channels of digital media. The digital media includes audio and can also include video.

In the drawings, the use of common reference numerals is for convenience only and is intended to indicate common components that can be used across the different units described below. It will be appreciated that the common components will be configured for use in their particular environments and are not necessarily identical, even though they are labelled with common reference numerals.

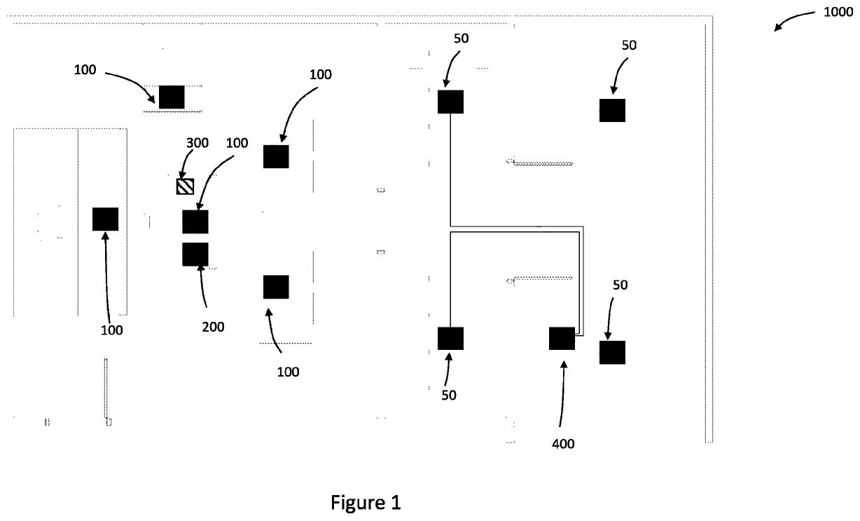

The communications system 1000 (FIGS. 1 to 3) is configured for providing two-way transmission of sound in venues where multiple parties are involved, and where clear transmission of sound is required for recordal purposes, for clarity of oral communications, and, optionally, for transcription software. Examples of such venues are courtrooms or any other venues in which hearings and other similar proceedings are heard. Other venues can be those in which discussions or negotiations between multiple parties occur and need to be recorded and/or clearly heard.

The communications system 1000 includes several communications units 100, each one being located near a participant or a group of participants. The communications units 100 are connected to each other by the digital network 2000, such as a multi-channel, digital media network. The network 2000 can be an Audio Video Bridging (AVB) network or any other network capable of integrating media and control of a system in multiple data streams over a single, IP network. Another example of a suitable network is that known as a Dante (trade mark) network that is provided by Audinate Pty Ltd.

The communications units 100 are hardwired to the network 2000 by an ethernet cable, for example, an Ethernet (IEEE 802.3) cable. Instead, a wireless connection operating on the 8021.11 Wi-Fi wireless protocol, or any other suitable wireless protocol, such as Bluetooth™ and Wireless IoT Network Protocols can be used to connect the communications units 100 to the network 2000.

Each communications unit 100 includes processing circuitry for conversion of sound to digital electronic transmissions, and vice versa, for example with suitable DSP or ADC circuitry. The analogue to digital conversions may take place in a single dedicated DSP, such as those described below. Instead, the conversions may take place in respective components within the communications unit 100. The communications unit 100 is described in further detail below.

The communications system 1000 includes one or more I/O units 200. Each I/O unit 200 provides connectors for connecting external media devices to the digital network 2000, so that audio and video signals can be transmitted and received to and from the digital network 2000, respectively. Examples of external media devices include cameras and discrete microphones and other remote terminals such as those that might be found in a holding cell. The I/O units 200 can be used for sending audio signals to a recording device for recording the audio signals, or to a translator for translation. The I/O unit 200 is described in further detail below.

The communications system 1000 includes amplifier units 400. Each amplifier unit 400 is configured for receiving digital audio signals from the I/O units 200 and/or the communications units 100, and amplifying the signal, before sending it to the other communications units 100 and/or the I/O units 200. The operation of the amplifier unit 400 is described in further detail below.

The communications system 1000 includes a network switching device such as a router 2200. The communications units 100, I/O units 200 and amplifier units 400 are each connected to the router 2200 by ethernet cables. In this way, digital audio signals or digital audio streams can be routed by the router 2200 to the correct endpoints. This can happen using IP protocols or other suitable communications protocols.

The communications system 1000 can include a network audio processor 600. The network audio processor 600 processes the digital audio streams to provide acoustic echo cancellation, and to ensure that input (for example a person's voice) from a communications unit 100 is not returned to that communications unit 100 as output. Such network audio processors 600 are known, and are sold, for example, by BiAmp Systems. Digital audio streams from each of the communications units 100 and the I/O units 200 are sent to the network audio processor 600 for processing via the router 2200.

Such audio processing could be carried out at the communications units 100 by a micro-controller that is built into the communications units 100, as described below.

The communications system 1000 includes speakers 50 that can be connected directly to the amplifier unit 400.

A central controller 300 can be connected to the network as part of the communications system 1000. The central controller 300 is configured to receive and transmit signals to any one of the communications units 100, the I/O units 200 and the amplifier unit 400. The operation of the central controller 300 is described in further detail below.

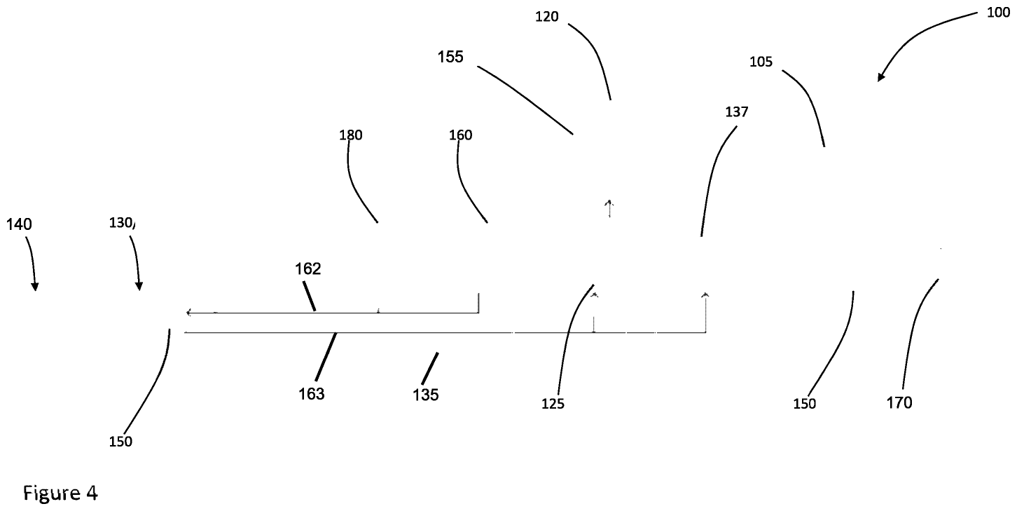

Any control functions described as being carried out by a controller on any of the communications unit 100, I/O unit 200 or amplifier 400 (the “units”) could be carried out by the central controller 300, and vice versa, with any of the control functions described for the central controller 300 being capable of being carried out by any one or more controllers in the form of micro-controllers 150, 250, 450 in the units (FIGS. 4 to 6). The units could be operable without a central controller, relying on their internal controllers or micro-controllers. Each of the micro-controllers 150, 250, 450 is envisaged as being autonomously operable to control that unit's functions, and to communicate effectively with any of the other units. Thus, in situations where multiple units are used, a level of redundancy is provided with other micro-controllers 150, 250, 450 being configured to control operation of the system 1000 should any one of the units or micro-controllers fail.

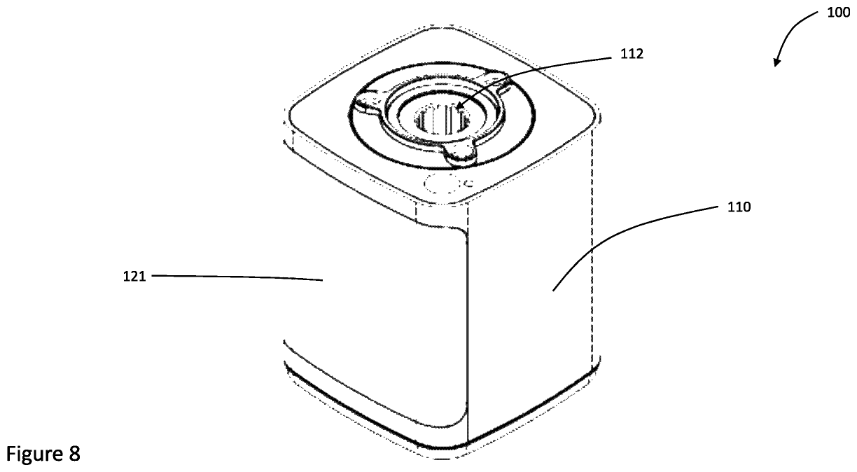

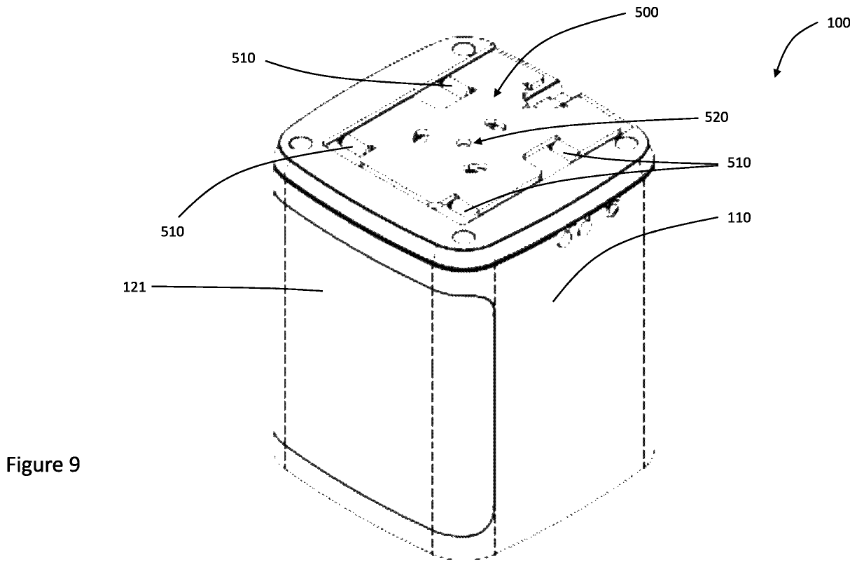

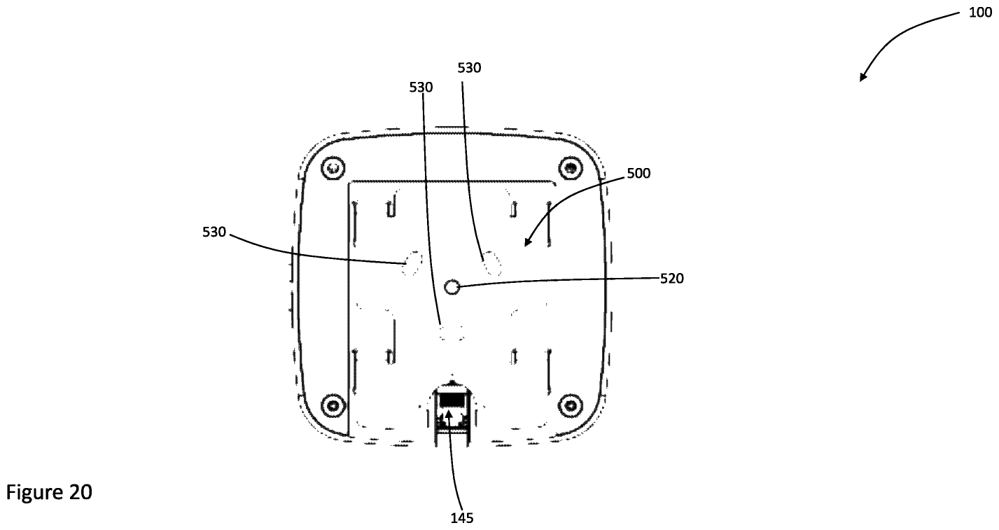

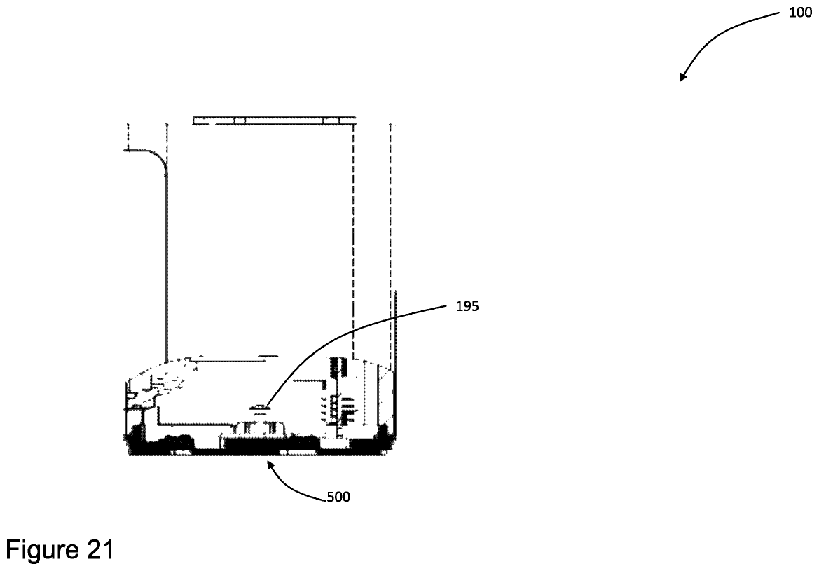

The communications unit 100 is shown in FIGS. 4, 7 to 12 and 19 to 22.

The communications unit 100 includes a housing 110 and an audio output in the form of an array of speakers 120 mounted on the housing 110. The unit 100 also includes a digital signal processor (DSP) 130, a network interface in the form of an ethernet interface 140 and the micro-controller 150. The ethernet interface 140 is configured for connection to the network 2000. As set out above, the ethernet interface can be substituted with an appropriate wireless interface, depending on the nature of the network 2000.

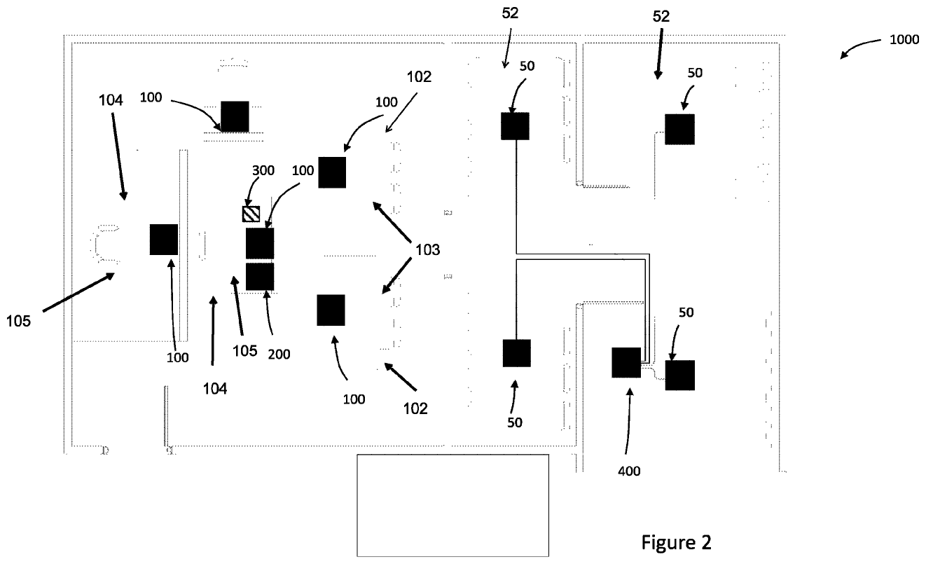

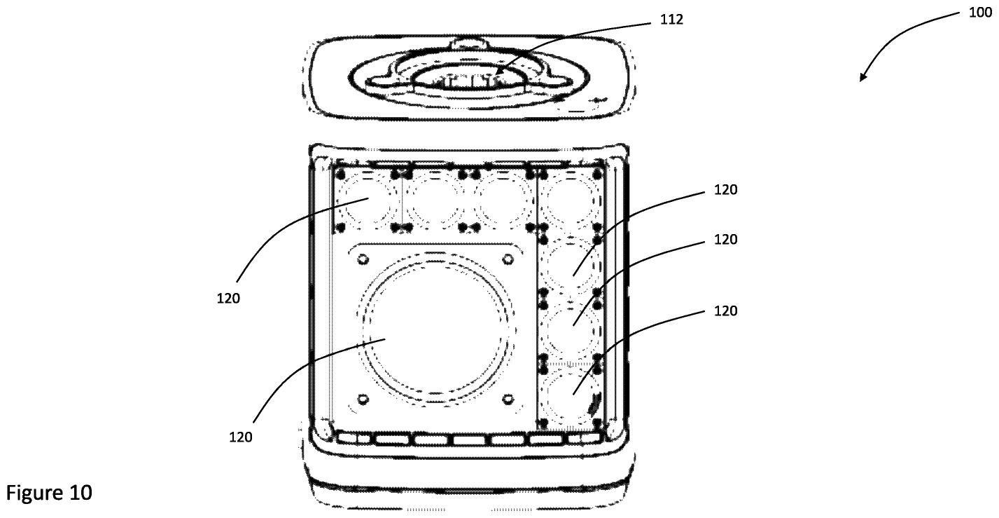

The speakers 120 are arranged on the housing 110 as a dual line array of speakers as shown in FIG. 10. The speakers 120 are covered by a speaker cover 121. In this arrangement, the speakers 120 are configured to generate sound output in a variety of dispersion patterns. Operation of the speakers 120 is controlled by the micro-controller 150 as described below. The speakers 50 can also be in the form of arrays of speakers that are configured to generate sound output in a variety of dispersion patterns. In that case, the controller 300 can be configured to control operation of the speakers 50 in an appropriate manner. For example, the speakers 50 and the controller 300 can be configured to generate the sound footprints 52 has shown in FIG. 2 which would be appropriate for participants or attendees located in regions zones near the footprints 52.

The speakers 50, 120 can be class D bi-amplified speakers. The speakers 120 can be in the form of two rows of minor speakers oriented orthogonally with respect to each other and a single major speaker. The minor speakers can be tweeters and the major speaker can be a subwoofer.

The interface 140 is operatively connected to the micro-controller 150, via the DSP 130, to facilitate communication between the micro-controller 150 and other components on the network 2000. Such communication can be by way of various IP protocols or some other communications protocol, depending on the application.

The micro-controller 150 is configured for processing software instructions, and can include digital storage media for storing software instructions and/or data. The micro-controller 150 is configured for communicating with the DSP 130 via a System Control Bus 135. Thus, an external controller, such as the controller 300, can have a level of control over the micro-controller 150. For example, the controller 300 can be used to provide the micro-controller 150 with operational parameters. Such parameters could be determined by the relevant venue, size of audience, and various other characteristics.

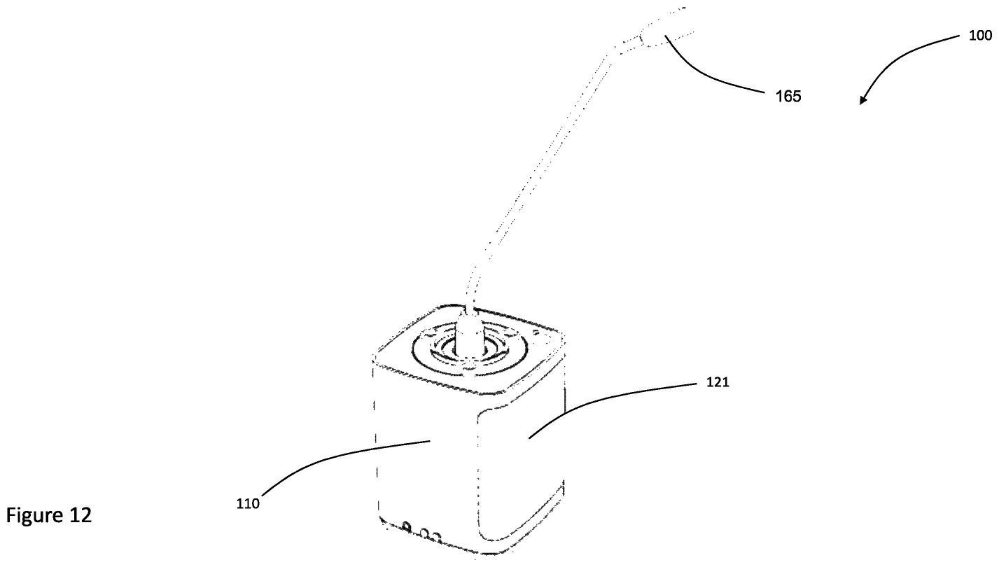

The communications unit 100 further includes an analogue input 160. The analogue input 160 is configured for connection to a sound source in the form of a microphone 165 (FIG. 12). The analogue input 160 can include a microphone connection mechanism in the form of a recess or socket 112 in the housing 110 for electrical connection of a plug of the microphone 165, in a detachable manner. The microphone 165 need not be removable and can form part of the communications unit 100.

The analogue input 160 is a balanced analogue input.

The analogue input 160 includes pre-amplification circuitry incorporating an analogue to digital converter. The pre-amplification circuitry can include Burr-Brown (trade mark) analogue to digital conversion circuitry.

The analogue input 160 is connected to the DSP 130 via a Digital Audio Bus IN 162. The analogue input 160 generates an audio signal that is transmitted to the DSP 130 via the Digital Audio Bus IN 162. The DSP 130 is configured to process the audio signal for subsequent transmission of digital signals to the network 2000 via the interface 140. These digital signals can then be transmitted to any other communications device(s) or other peripherals, such as the units described below, connected to the network 2000 under the control of an external controller, such as the central controller 300. The central controller 300 can be configured to deliver the digital signals to an appropriate device, for example, a device located near an authority, such as a judge, where the digital signals are converted to analogue signals, amplified, and emitted by speaker(s) of that device. The device can be another communications unit 100 so that those speakers are the speakers 120. An example of positions for the units 100 is shown in FIGS. 1 and 2.

The analogue input 160 is also operatively connected to the micro-controller 150 and the DSP 130 via the System Control Bus 135 so that the analogue input 160 can be controlled with the microcontroller 150.

The communications unit 100 includes a pair of amplifiers 125, using one to power each of a low range driver and a high range driver to increase acoustic performance. The amplifiers 125 are connected to the System Control Bus 135 for control, at least by the micro-controller 150.

The amplifiers 125 are connected to a Digital Audio Bus OUT 163. The Digital Audio Bus OUT 163 is also connected to the DSP 130 so that digitised audio signals can be received by the amplifiers 125 for digital to analogue conversion and amplification to drive the speakers 120.

The amplifiers 125 are connected to the speaker array 120 via a speaker array controller 155. The micro-controller 150 is operatively connected to the speaker array controller 155 to control operation of the speaker array 120, for example, to determine or select a dispersion pattern of the speaker array 120.

The micro-controller 150 is operatively connected to the amplifiers 125 via the Digital Audio Bus OUT 163. Thus, the amplifiers 125 can be controlled with the micro-controller 150.

The communications unit 100 includes an integrated headphone amplifier 137 (FIG. 4) that facilitates services such as multi-language translation or hearing assistance. The amplifier 137 is also connected to the Digital Audio Bus OUT 163 so that the amplifier 137 can be controlled with the micro-controller 150.

The communications unit 100 further includes a presence detector 170 for detecting the presence of a person near the communications unit 100. The presence detector 170 is operatively connected to the micro-controller 152 to transmit signals indicating the presence of the person to the micro-controller 152. The presence detector 170 can incorporate a wide variety of sensors, including infrared, microwave, laser, or any other suitable sensors.

The micro-controller 150 is configured to control the operation of the speakers 120 in accordance with values represented by signals received from the presence detector 170. In the embodiment shown, the micro-controller 150 is configured to select between three or more dispersion patterns in which the speakers 120 can be controlled to operate, to provide the clearest sound to the detected user(s). For example, if the presence detector 170 detects that several participants are disposed around the communications unit 100, the micro-controller 150 may select an omnidirectional dispersion pattern. Alternately, if the presence detector 170 detects that a single person is located standing above and near the communications unit 100, the micro-controller 150 may select a vertical dispersion pattern. Further, if the presence detector 170 detects several users sitting to one side of the communications unit 100, the micro-controller 150 may select a horizontal dispersion pattern.

Examples of such patterns can be found in FIG. 2. For example, two participants can be seated in zones 102, with a dispersion pattern 103 generated by the speaker array 122 to emit sound into the zones 102. One participant can be seated in each of zones 104, with dispersion patterns 105 generated by the speaker arrays 122 to emit sound into the zones 104.

The micro-controller 150 can be configured to turn the speakers 120 off if no user is detected by the presence detector 170.

The micro-controller 150 can be configured to adjust the volume of the speakers 120 according to the detected location of the user.

The micro-controller 150 can use the signal received from the presence detector 170 to adjust the sensitivity of the microphone 160. For example, the micro-controller 150 can adjust a sensitivity of an analogue input to accommodate a location of a participant relative to the communications unit 100. Thus, sensitivity can be increased as the participant moves away from the unit 100.

The communications unit 100 includes a human machine interface in the form of at least one manual input device, for example, an input button 105. The manual input device could be a non-mechanical type device such as a touch screen.

The input button 105 can be used, for example, as a mute button, or to register a vote. It is envisaged that the central controller 300 or the micro-controller 150 can allocate different functionality to the input button, so that actuating the input button can have different effects. The communications unit 100 further includes a visual indicator in the form of an LED light, for indicating that the input button has been actuated.

The actuation of the input button 105, as a mute button, can cause the micro-controller 150 to deactivate the analogue input 160. Alternately, the input button 105 can function so that, when pressed, the analogue input 160 remains active, but the audio signals are not converted to sound and other devices, such as other communications units 100, while recording can still take place. Alternately, actuation of the mute button can cause the transmission of a signal to the central controller 300, which then transmits a control signal back to the communications unit 100, on which the mute button has been actuated, to deactivate the analogue input 160. In this way, recordal of the actuation of the mute button as an event is possible.

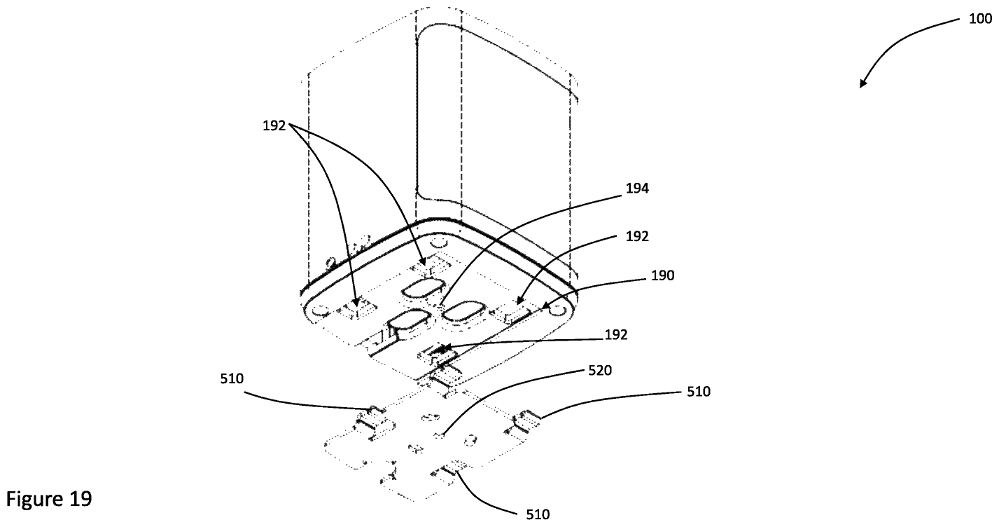

The communications unit 100 includes mounting formations 190 (FIG. 19) for mounting the apparatus to a mounting bracket 500. The mounting formations 190 include sliding mounting formations in the form of slots 192 for slidably receiving lugs 510 on the mounting bracket 500, and a securing formation in the form of an aperture 194 for receiving a fastener such as a screw. The aperture 194 is configured to align with a threaded aperture 520 in the mounting bracket 500 when the lugs 510 have been slidably received into the slot 192. The screw is inserted through the aperture 194 and screwed into the threaded aperture 520 to prevent the lugs from sliding out of the slot 192. The mounting bracket 500 also includes securing formations in the form of screw apertures 530 for securing the mounting bracket to a fixed external object such as a table or counter. In this way, theft of the communications unit 100 is discouraged or impeded.

The communications unit 100, the I/O connector interface unit 200, and the amplifier unit 400 include similar mounting formations for mounting to a mounting bracket 500.

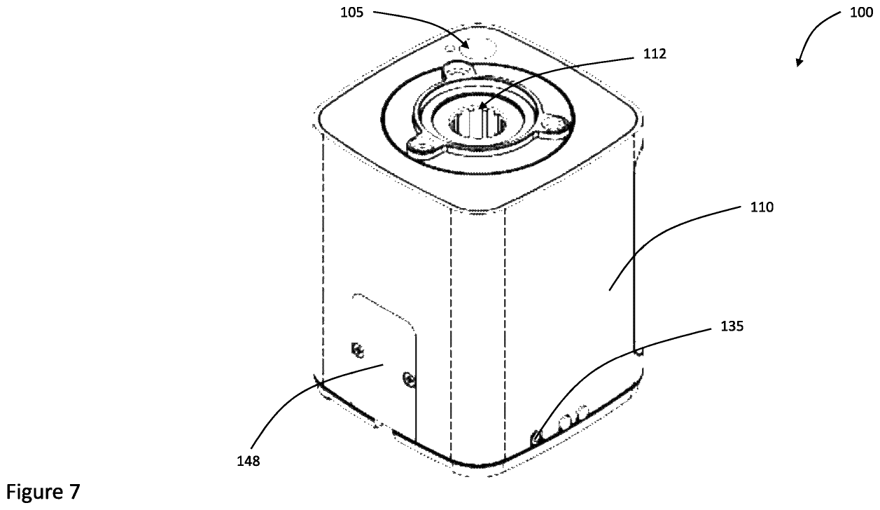

The communications unit 100 further includes headphone connecting formations 135 (FIG. 7) for connecting a headphone to the communications unit 100.

The communications unit 100 includes a digital reference microphone 180 that can be used to detect ambient noise and to generate an audio signal representing the ambient noise such as room or crowd noise. The controller 150 is also configured to allow for the filtering of the digital audio signal before it is transmitted, by removing the room or crowd noise picked up by the reference microphone 180. Similarly, any digital audio signal can be equalised, or a dynamic range control function can be carried out by the controller 150 on the digital audio signal before transmission via the transmitter 140.

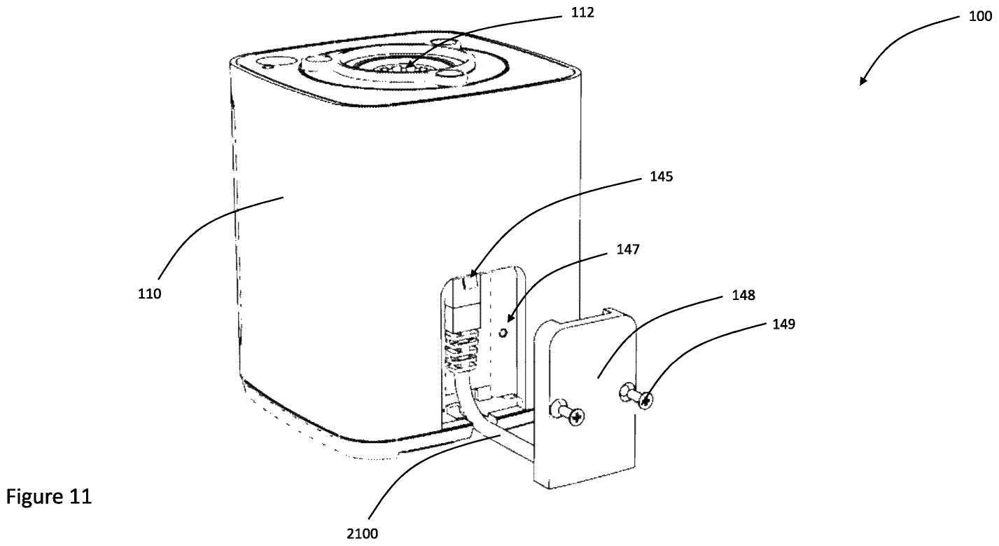

In the embodiment shown in FIG. 11, the communications unit 100 includes cable connector formations 145 for connecting a cable 2100, such as an ethernet cable. The cable connector formations 145 are located within a recess 147, and the recess 147 is partially concealed by a cover 148. The cover 148 is secured onto the housing 110 by fasteners such as screws 149. In this way, the cable 2100 is inhibited from disconnection.

The I/O unit 200 and amplifier unit 400 can have similar cable connector formations.

The interface 140 is configured to supply power over ethernet (PoE) to the components of the communications unit 100.

The DSP 130 can be configured to define on-board filters. The DSP 130 can be configured to provide equalisation and dynamic range control to facilitate the provision of lossless high-quality audio and system protection while facilitating the reduction of external digital signal processing requirements.

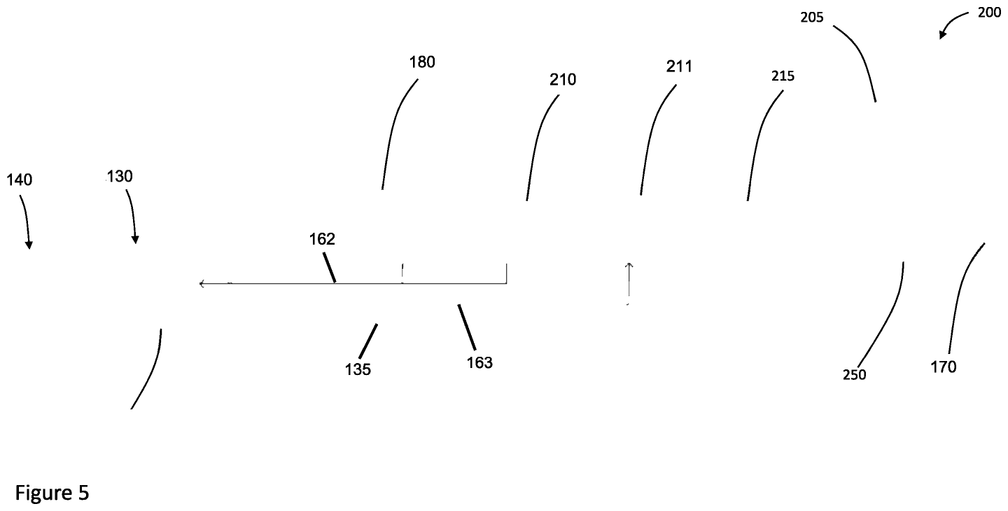

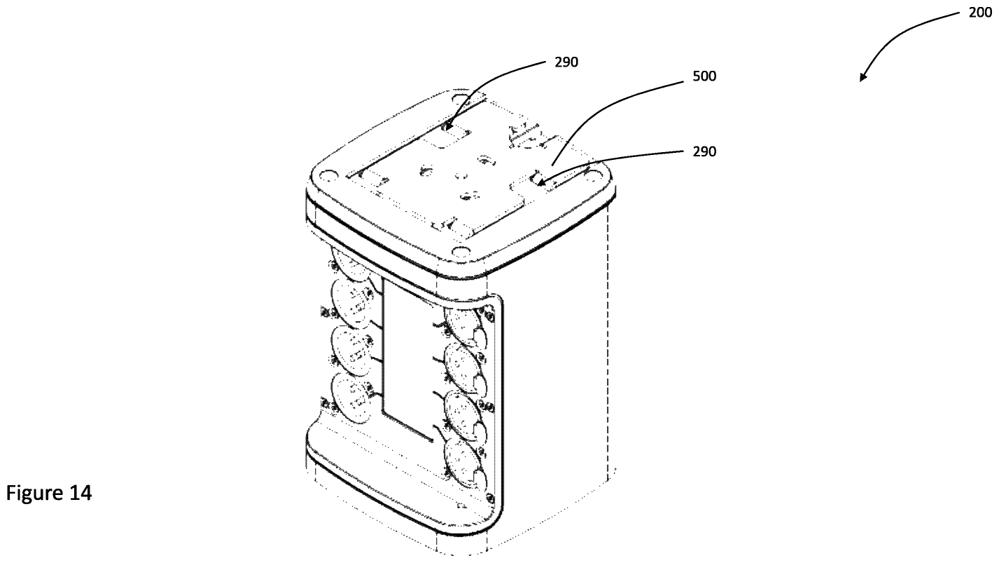

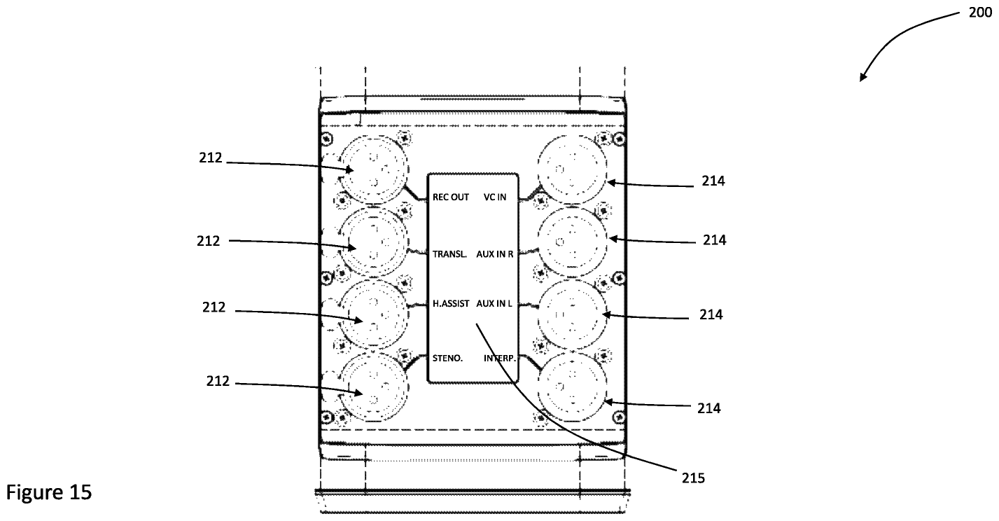

The I/O unit 200 is shown in FIGS. 5 and 13 to 15. The I/O unit 200 provides an interface including several connectors for connecting of external media devices to the network 2000. With reference to the above paragraphs, like reference numerals refer to like parts, unless otherwise specified. The use of such common reference numerals is for convenience and is not intended to indicate that the relevant components of identical across the embodiments.

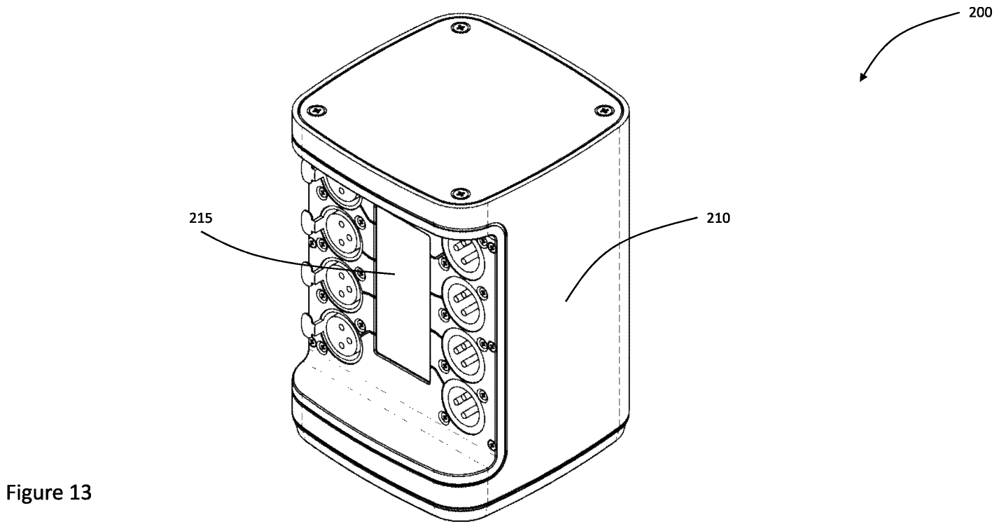

As shown in FIGS. 13 to 15, the I/O unit 200 includes a housing 210, four output connector sockets 212 configured for the connection of plugs carrying various audio signals, such as those provided by a translation service, a stenographer, et cetera. The I/O unit 200 also includes four input sockets 214 configured for the connection of plugs carrying various audio signals such as left and right auxiliary signals, interpretation audio, et cetera. These can be used for receiving signals from a remote terminal.

The I/O unit 200 includes a multi-channel analogue input 210 that is operatively connected to the input sockets 214 and the Digital Audio Bus IN 162 for receiving input audio and transmitting a corresponding digital signal to the DSP 130 via the Digital Audio Bus IN 162. Thus, the input 210 can be a four-channel analogue input. The input 210 can also be a balanced input.

The input 210 is also connected to the System Control Bus 135 so that the micro-controller 250 can control operation of the input 210.

The I/O unit 200 includes an analogue output in the form of a multi-channel analogue output 211 that is operatively connected to the output sockets 212 and the Digital Audio Bus OUT 163 for receiving digitised audio signals from the DSP 130 and transmitting corresponding analogue audio signals to the output sockets 212.

The output 211 is also connected to the System Control Bus 135 so that the micro-controller 250 can control operation of the output 211.

Thus, the I/O unit 200 defines an audio interface between peripheral devices and the network 2000. The I/O unit 200 can also define a video interface between the peripheral devices and the network 2000.

The I/O unit 200 includes a reconfigurable digital display 215, preferably in the form of a microencapsulated electrophoretic display, such as those sold by E-Ink Inc. The digital display 215 is connected to the System Control Bus 135 to be controlled by the micro-controller 250, or by the central controller 300 via the network 2000. Control of the digital display 215 by the micro-controller 250 or the central controller 300 is set out in more detail below.

The I/O unit 200 also includes the presence detector 170 operatively connected to the micro-controller 250. Further, the housing 210 of the I/O unit 200 is also mountable to a mounting bracket 500 as with the communications unit 100, having mounting formations 290 provided therefor.

The I/O unit 200 includes Ethernet cable connector formations (not shown) as with the communications unit 100 to connect the interface 142 to the network 2000.

The I/O unit 200 can also include headphone connector formations (not shown), and a headphone preamplifier provided therefor.

The I/O unit 200 includes a human machine interface (HMI) 205. The HMI 205 can take various forms such as a button actuator as described with reference to the HMI 105 of the communications unit 100. The HMI 205 can include a high-resolution screen to provide feedback for an operator. The HMI 205 is connected to the micro-controller 250 to permit the operator to adjust operational characteristics of the I/O unit 200, via the micro-controller 250.

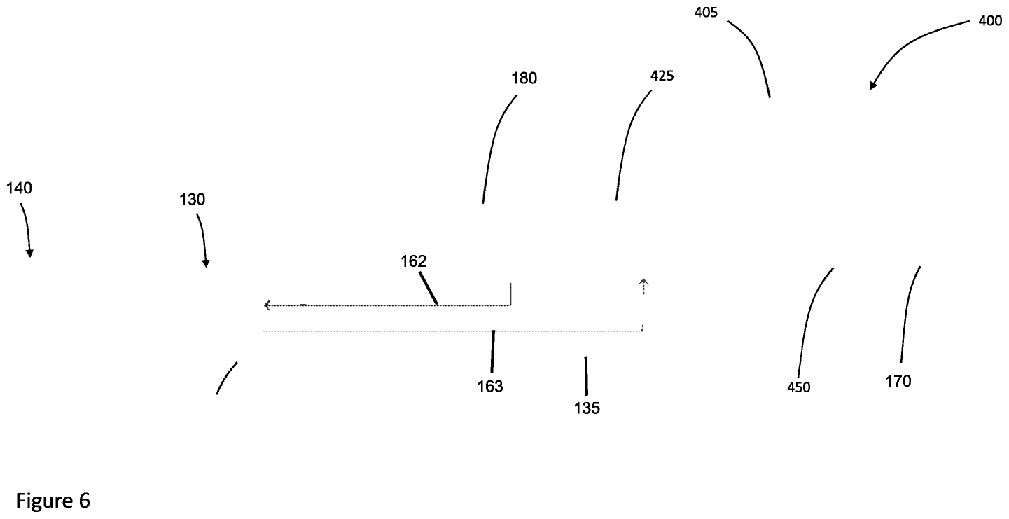

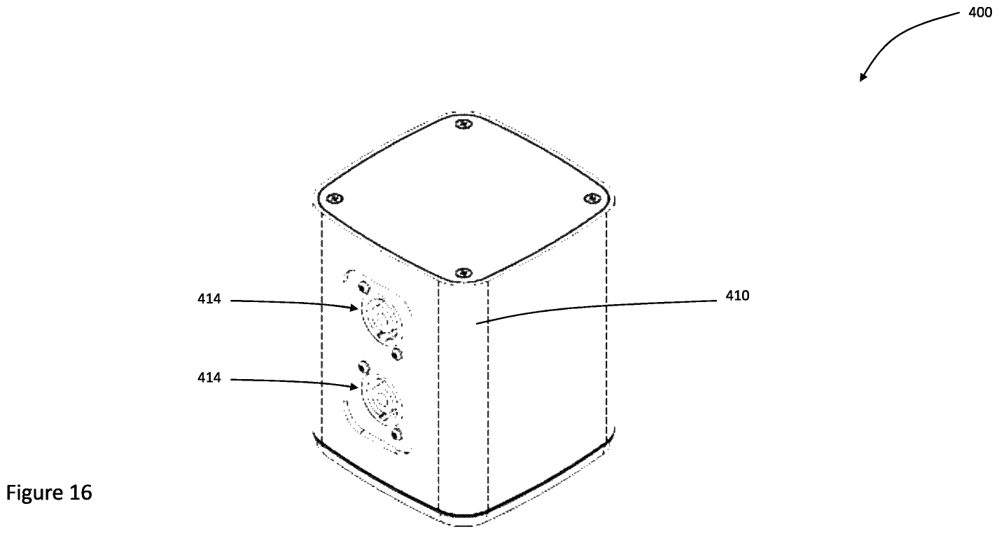

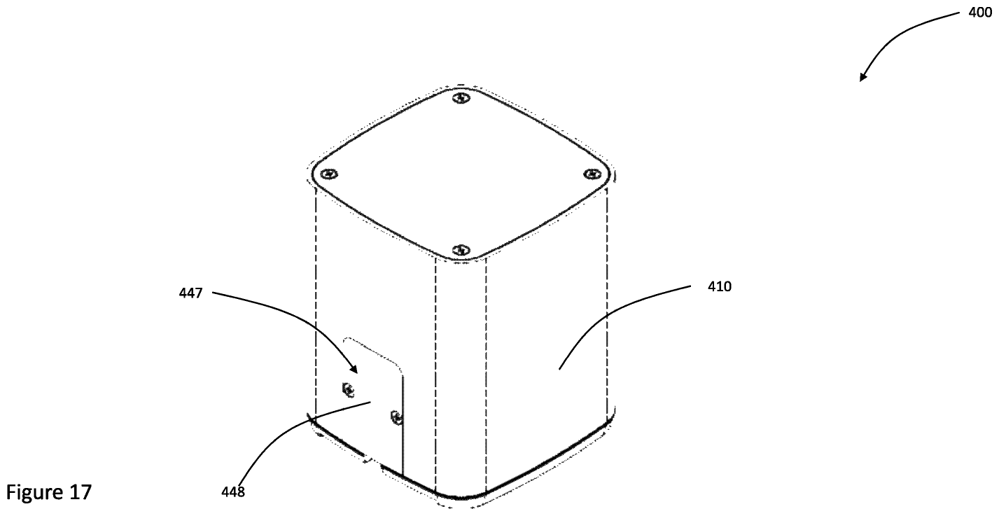

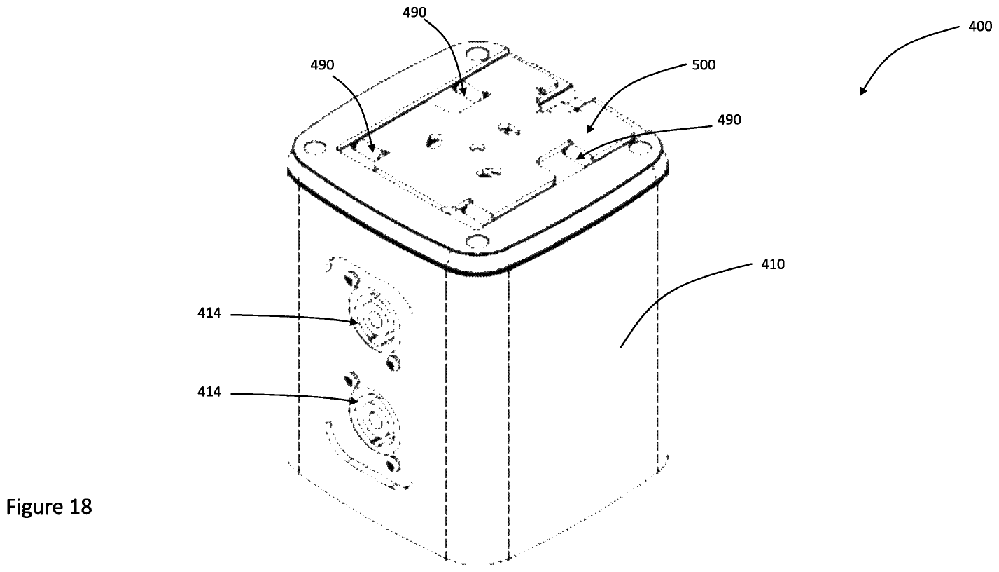

The amplifier unit 400 is shown in FIGS. 6 and 16 to 18. With reference to the preceding paragraphs, like reference numerals refer to like parts, unless otherwise specified. The use of the like reference numerals is intended for convenience only and should not be regarded as requiring that the parts or components with common labels be identical.

The amplifier unit 400 drives the speakers 50 directly, for example to broadcast sound to a public gallery in a court house.

The amplifier unit 400 includes a housing 410 like that of the communications unit 100, in that it includes cable connector formations (not shown) for connecting to the network 2000 via an ethernet cable, and mounting formations 490 for mounting the housing 410 to a mounting bracket 500 in a similar fashion to that of the IO unit 200 and the communications unit 100.

The amplifier unit 400 further includes an amplifier in the form of a multi-channel amplifier 425. For example, the amplifier 425 is a four-channel amplifier. The amplifier 425 incorporates drivers for driving the speakers 50. The amplifier 425 is connected to the Digital Audio Bus OUT 163 to receive digitised audio signals from the network interface 140, via the DSP 130, and to transmit amplified analogue signals to a pair of output connector sockets 414.

The amplifier unit 400 includes the micro-controller 450. The micro-controller 450 and the amplifier 425 are connected to the System Control Bus 135 so that the micro-controller 450 can control operation of the amplifier 425.

The controller 450 is further configured with on-board filters, equalisers and dynamic range control as with the I/O connector interface unit 200 and the communications unit 100. The micro-controller 450 is also controllable over the network 2000 by the central controller 300.

The amplifier unit 400 includes an HMI 405 that is similar to the HMI 105, 205. Thus, the HMI 405 is configured to permit an operator to adjust the operating parameters or characteristics of the amplifier unit 400.

The amplifier unit 400 includes mounting formations 490 for mounting to a mounting bracket 500 as with the communications unit 100. The amplifier unit 400 also includes cable connector formations located in a recess 447 and covered by a cover 448. This arrangement can be like the arrangement described above with reference to the communications unit 100 shown in FIG. 11.

By providing an amplifier unit 400, the risk of downtime in the event of a single component failure such as the amplifier, is lessened, as the amplifier unit 400 can be easily replaced.

A manual input device can be provided on any of the I/O unit 200 or the amplifier unit 400. For example, the manual input device of the amplifier unit 400 can form part of the human machine interface (HMI) 405 as shown in FIG. 6 and as described above.

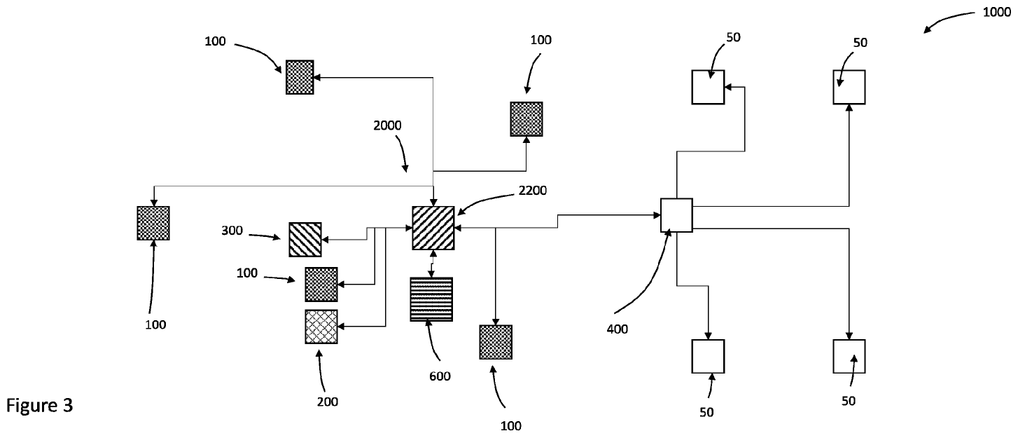

The central controller 300 (FIG. 3) is also connected to the network 2000 via an ethernet cable 2100. The central controller 300 includes a user input device, preferably in the form of a touchscreen, and includes a processor and digital storage media for storing software instructions.

The central controller 300 is configured to transmit mute signals to any of the communications unit 100, amplifier 400 and/or IO unit 200 to prevent sound being picked up at those units and transmitted through the network 2000. Additionally, and/or alternatively, the central controller 300 is configured to transmit mute signals to any one or more of the communications unit 100, amplifier 400 and I/O unit 200 to prevent transmitted digital audio signals received by those units being converted into sound. In this way, the microphones at those units can pick up and transmit sounds detected by the microphone near the units, and the sound can be recorded by recorders via the I/O connector interface unit 200, but not generated as sound waves over the speakers 50 and/or the communications unit 100.

It is further envisaged that the central controller 300 can include digital instructions that allow pre-programmed muting to occur. For example, on occasion, a judge or magistrate will call the opposing attorneys aside for a confidential discussion or sidebar. It may be useful to record such a confidential discussion via the microphones 160, without conveying what was said to the public gallery, or to the parties.

For the central controller 300 to control operation of the controllers 150, 250, 450 it can be pre-programmed by inputting a “sidebar” selection that selects which aspects of which units to mute. The central controller can then display a list of input buttons that, when actuated, cause the central controller 300 to carry out the pre-programmed muting. This could, for example, be carried out to prevent generation of transmissions to be produced as sound emitted by the speakers 50, 120, while still transmitting digital audio signals to a recording device via the I/O connector interface unit 200 for recordal.

Each of the communications units 100, I/O units 200, amplifier units 400 and central controller 300 is powered via the ethernet connection or interface 140, using Power over Ethernet (PoE) technology. In this way, the amount of cables can be further reduced.

It is envisaged that the central controller 300 will further be configured for receiving proximity signals from each of the units 100, 200, 400 to establish whether certain units should be used at all, thereby conserving power, and reducing the overall ambient noise levels, thereby creating circumstances for better sensing, recordal and transmission of speech. Further, the digital reference microphones 180, 280 and 480 in each of the units can be transmitted to the central controller 300 for processing, to thereby establish a better reference signal for the ambient noise levels.

Where typical layouts are commonly used for different types of court sessions, the central controller can be configured to assist in the setup of the various layouts, by transmitting display signals for display on the digital display 215 of the I/O connector interface unit 200. This can guide laypersons during the setup of the communications system 1000.

The foregoing description is by way of example only, and may be varied considerably without departing from the scope of the present invention. For example, only the communications unit 100 and amplifier unit 400 can be used in the communications system 1000. In another example, several 10 connector interface units 200 can be connected to the AVB network 2000.

The number, placement, shape and capacity of the units 100, 200 and 400 may be varied.

Any of the units can include a video camera, and video signals can be transmitted and received over the network 2000 as with the audio signals. In another embodiment (not shown), any of the units can include a screen for the display of video signals received over the AVB network. Further, the central controller 300, or any of the localised micro-controllers 150, 250, 450 can be controlled to provide a video “muting” function, whereby video can be shut down to particular units according to a pre-programmed pattern. In addition to the provision of speakers, display screens can be provided as part of the communications system 1000.

Any of the audio and/or video signals received or transmitted can be recorded on associated digital storage media on any one of the units, the central controller and/or the network audio processor 600. The digital storage media can be associated with the controllers 150, 250, 450, or the processors of the network audio processor 600 and/or the central controller, or can be external digital storage media plugged into these. External digital storage media such as a hard drive can be plugged into the router 2200, and audio and/or video signals and associated data can be stored on the storage media.

In this way, a communications system of autonomously operating units can be provided that:
allow for the use of a single ethernet cable,
are individually replaceable in the event of failure, so providing redundancy,
allow for convenient connection and interoperability,
have on-board control of their own functionality, and their interaction with other units, but can also be controlled centrally,
are easily set up and installed,
guide the installer in the connection of external media, and
allow for pre-programmability in terms of the audio and/or video muting functionality, for use in specific pre-envisaged events.

The system 1000, is suited for use in a method of distributing media on a local area network, the network 2000, as described above. The media can be in the form of audio and/or video, as is apparent from the above paragraphs.

The features described with respect to one embodiment may be applied to other embodiments, or combined with or interchanged with the features of other embodiments, as appropriate, without departing from the scope of the present invention. The use of like reference numerals to refer to like parts is for convenience only and should not be regarded as limiting the scope of the appended claims.

Various embodiments of the communications unit include:

a plurality of speakers for transmitting sound waves as audio output, the speakers configured to generate sound output in a plurality of dispersion patterns;

a controller configured for processing software instructions;

a receiver configured for receiving digital signals, the receiver being operatively connected to the controller to direct received signals to the controller for processing;

a transmitter operatively connected to the controller and configured for transmitting signals as directed by the controller; and

wherein the controller is configured for converting digital audio signals received via the receiver into a suitable format for transmission to the speakers for the generation of soundwaves.

There is provided a communications system suitable for use in a courthouse, the communications system having at least one or more communications units as described above.

In one embodiment, the communications system includes a network switching device.

In one embodiment, one or more selected from the communications units, I/O unit and amplifier unit are connected to the network switching device.

In one embodiment, the communications system further includes a network audio processor for processing audio signals from the communications unit and/or I/O unit.

In one embodiment, the network audio processor is connected to the network switching device.

In further embodiments, there is provided an I/O unit for the input and output of signals into a communications system, the I/O unit including:

a housing;

one or more connector plugs or sockets, each connector plug or socket being one or more selected from:

input connector plugs/sockets for receiving a signal from a remote terminal; and

output connector plugs/sockets for transmitting a signal to a remote terminal; and

a digital display associated with each of the connector plugs/sockets and/or the output connector plugs/sockets, the digital display being controlled by a controller

Further embodiments include a controller for controlling a communications system suitable for use in a courthouse.

The controller can include:

a processor configured for processing software instructions and configured for directing the transmission of signals from a transmitter;

a receiver configured for receiving digital signals over a network, the receiver being operatively connected to the processor to direct received signals to the processor for processing;

a transmitter operatively connected to the processor and configured for transmitting signals as directed by the processor; and

digital storage media configured for storing data and instructions, the instructions being configured for directing the processor to carry out the steps of:
receiving an input identifying the presence of a plurality of communications modules or units on a network;
receiving an input indicating which of the identified communications units to mute on the actuation of an actuation input;
receiving an actuation input; and
transmitting a mute signal to each of the identified communications modules or units indicated for muting.

In the present specification and claims, the word “comprising” and its derivatives including “comprises” and “comprise” include each of the stated integers, but does not exclude the inclusion of one or more further integers.

Other embodiments of the invention will be apparent to those skilled in the art from consideration of the specification and practice of the invention disclosed herein. It thanks of is intended that the specification and examples be considered as exemplary only, with a true scope and spirit of the invention being indicated by the following claims.

1-26. (canceled)

27. A communications system that includes:
a local area network that is configured for streaming multiple channels of digital media; and
a plurality of communications units, each communications unit including:
a network interface configured for connecting the communications unit to the network;
a digital signal processor connected to the network interface to process signals received from and sent to the network;
an analogue input for connection to a sound source, the analogue input being connected to the digital signal processor so that analogue signals generated by the analogue input can be digitised and received by the network, via the digital signal processor;
an audio output that is configured to generate sound output, the audio output being connected to the digital signal processor so that a digital input from the network can be processed into analogue signals for the audio output; and
a controller that is configured to control operation of the communications unit.

28. The communications system as claimed in claim 27, wherein each communications unit includes an amplifier that is connected between the digital signal processor and the audio output to amplify the analogue signals for the audio output.

29. The communications system as claimed in claim 27, wherein each communications unit includes a reference microphone that is configured to detect ambient noise and to generate an audio signal representing the ambient noise such that the audio signal can be used to filter out the ambient noise.

30. The communications system as claimed in claim 27, wherein each communications unit includes a housing, the audio output being a speaker array that is mounted on the housing.

31. The communications system as claimed in claim 30, in which the audio output includes a speaker array controller connected to the speaker array so that the speaker array can generate sound output in different dispersion patterns.

32. The communications system as claimed in claim 31, in which each communications unit includes a presence detector that is connected to the controller, the controller being configured to adjust a dispersion pattern of the audio output, via the speaker array controller, based on a signal received from the presence detector.

33. The communications system as claimed in claim 27, wherein the analogue input includes a microphone connection mechanism that is operatively connected to the digital signal processor and is configured to facilitate connection of the sound source in the form of a microphone to the communications unit in a detachable manner.

34. The communications system as claimed in claim 27, which includes at least one input/output (I/O) unit, the, or each, I/O unit including:
a network interface configured for connecting the I/O unit to the network;
a digital signal processor connected to the network interface;
an analogue input for connection to at least one analogue input device, the analogue input being connected to the digital signal processor so that digitised input signals from the at least one analogue input device can be received by the network, via the interface;
an analogue output for connection to at least one analogue output device, the analogue output being connected to the digital signal processor so that digitised output signals can be received by the analogue output and transmitted as analogue signals to the, or each, analogue output device; and
a controller that is configured to control operation of the I/O unit.

35. The communications system as claimed in claim 27, which includes at least one amplifier unit, the, or each, amplifier unit including:
a network interface for connecting the amplifier unit to the network;
a digital signal processor connected to the network interface;
an amplifier for connection to one or more speakers, the amplifier being connected to the digital signal processor so that digitised audio signals can be received by the amplifier from the network and converted into amplified analogue signals for the speakers; and
a controller that is configured to at least control operation of the amplifier unit.

36. A communications unit that includes:
a network interface configured for connecting the communications unit to a local area network that is configured for streaming multiple channels of digital media;
a digital signal processor connected to the network interface to process signals received from and sent to the network;
an analogue input for connection to a sound source, the analogue input being connected to the digital signal processor so that analogue signals received by the analogue input can be digitised and received by the network, via the digital signal processor;
an audio output that is configured to generate sound output, the audio output being connected to the digital signal processor so that a digital input from the network can be processed into analogue signals for the audio output; and
a controller that is configured to at least control operation of the communications unit.

37. The communications unit as claimed in claim 36, wherein the communications unit includes an amplifier that is connected between the digital signal processor and the audio output to amplify the audio signals for the audio output.

38. The communications unit as claimed in claim 36, which includes a housing, the audio output being a speaker array that is mounted on the housing.

39. The communications unit as claimed in claim 38, in which the audio output includes a speaker array controller connected to the speaker array so that the speaker array can generate sound output in different dispersion patterns.

40. The communications unit as claimed in claim 39, which includes a presence detector that is connected to the controller, the controller being configured to adjust a dispersion pattern of the audio output based on a signal received from the presence detector.

41. The communications unit as claimed in claim 36, which includes a reference microphone that is configured to detect ambient noise and to generate an audio signal representing the ambient noise such that the audio signal can be used to filter out the ambient noise.

42. The communications unit as claimed in claim 36, in which the analogue input includes a microphone connection mechanism that is operatively connected to the digital signal processor and is configured to facilitate connection of the sound source, in the form of a microphone, to the communications unit in a detachable manner.

43. A method of distributing media on a local area network that is configured for streaming multiple channels of digital media, the method including the steps of:
receiving and transmitting digital signals between a communications unit and the network via a network interface that is configured for connecting the communications unit to the network;
processing the digital signals with a digital signal processor connected to the network interface;
receiving analogue signals with an analogue input for connection to a sound source, the analogue input being connected to the digital signal processor;
digitising and transmitting the signals received from the analogue input to the network via the digital signal processor and the network interface;
receiving digitised audio signals from the network, via the network interface and the digital signal processor with an audio output; and
generating sound output with the audio output,

44. The method as claimed in claim 43, which includes the step of amplifying the audio signals with an amplifier connected between the digital signal processor and the audio output.

45. The method as claimed in claim 43, which includes the step of generating the sound output with a speaker array in a dispersion pattern.

46. The method as claimed in claim 45, which includes the step of detecting the presence of one or more participants with a presence detector and adjusting the dispersion pattern based on a signal received from the presence detector.
